(19) United States
(12) Patent Application Publication
(10) Pub. No.: US 2018/0128296 A1
(43) Pub. Date: May 10, 2018

(54) New connector

(71) Applicant: Yue Hong CHEN, GuangDong (CN)

(72) Inventor: Yue Hong CHEN, GuangDong (CN)

(21) Appl. No.: 15/599,453

(22) Filed: May 18, 2017

(30) Foreign Application Priority Data
Nov. 9, 2016 (CN) 201621218818.1

(51) Int. Cl. F16B 5/00

(52) U.S. Cl. CPC F16B 5/0036; F16B 5/0012; F16B 5/0004

(57) ABSTRACT

The invention discloses a new connector, comprising part 1 and part 2 as installed on the two objects to be spliced; the part 2 comprises a lug; transverse length of front part of the said lug exceeds that of the rear part; the part 1 comprises a cavity; transverse and vertical length and height of upper part of the cavity are respectively consistent with those of lug of the part 2; profile and size of the lower part of the cavity are consistent with those of lug of the part 2. The invention divides the connector into part 1 and part 2 for installation on the two objects to be spliced, which can realize quick splice of objects; moreover, it is also available for quick and easy separation as required.

### BACKGROUND OF THE INVENTION

The invention is related to a connector.

Currently, mutual connection between two objects is realized by means of such conventional approaches as fitting with binder, nail or screw and nut. However, such connection approaches are inconvenient, which are so complicated and difficult for operation by people without relevant experiences; moreover, the two objects are difficult for separation once connected, which can not satisfy requirements for such occasions as transportation.

### BRIEF SUMMARY OF THE INVENTION

In view of deficiencies to prior arts, the invention aims to provide a new connector as divided into part 1 and part 2 for installation on the two objects to be spliced; it can realize quick splice of objects, which is also available for quick and easy separation as required.

The invention is expected to provide the following technical solutions to achieve aforesaid purpose:

A new connector, comprising a part 1 and a part 2 as respectively installed on the two objects to be spliced; the part 2 comprises a lug; transverse length of front part of the said lug exceeds that of the rear part; the part 1 comprises a cavity; transverse and vertical length and height of upper part of the cavity are respectively consistent with those of lug of the part 2; profile and size of the lower part of the cavity are consistent with those of lug of the part 2.

It should be mentioned that when the two objects installed on part 1 and part 2 are to be spliced, the lug of part 2 is to be fully extended into the upper part of cavity of part 1 before moving downwards to insert the lug of part 2 into the lower part of the cavity of part 1 to realize connection of the two objects. It is quick and convenient, which can realize simple and easy separation of the two objects through reverse operation.

In a further embodiment, both sides of the part 2 are in a structure that bends inward.

Beneficial effect of the invention is stated as follows: It can realize quick splice of objects through part 1 and part 2 as divided for installation on the two objects to be spliced, which is also available for quick and easy separation as required.

### BRIEF DESCRIPTION OF THE DRAWINGS

FIG. 1 is the diagram for embodiment of part 1;

FIG. 2 is the diagram for embodiment of part 2;

FIG. 3 is the sectional diagram for embodiment of the lug of part 2;

FIG. 4 is the sectional diagram of embodiment of the cavity of part 1;

FIG. 5 is the diagram for embodiment of objects as connected with connector.

### DETAILED DESCRIPTION OF THE INVENTION

The following is the further description of the invention in combination with drawings. It should be mentioned that the invention has provided detailed implementation approaches and specific operation procedures based on the technical solution; however, protection scope of the invention is not limited to the embodiment.

A new connector, comprising a part 1 and a part 2 for installation on the two objects to be spliced

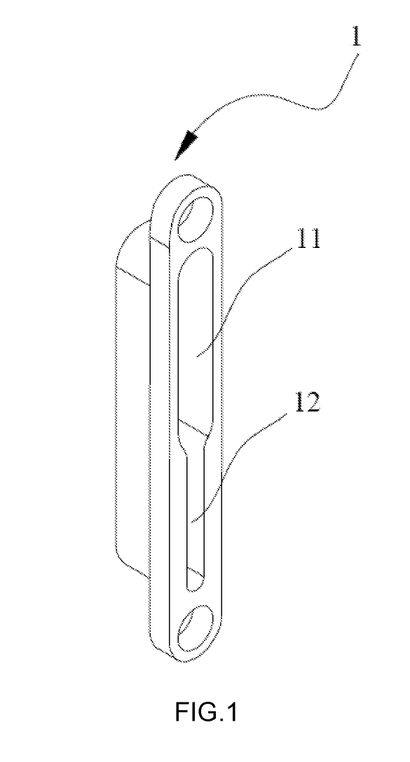

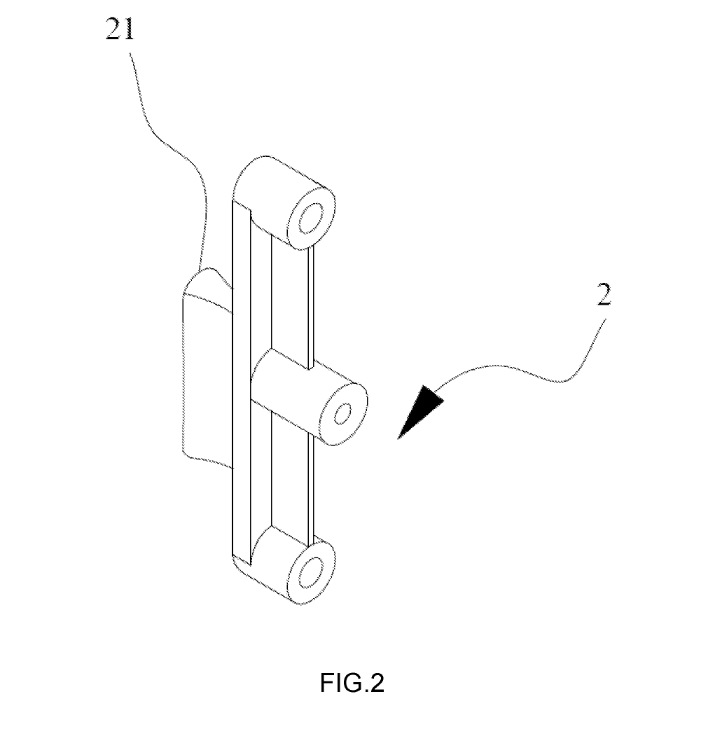

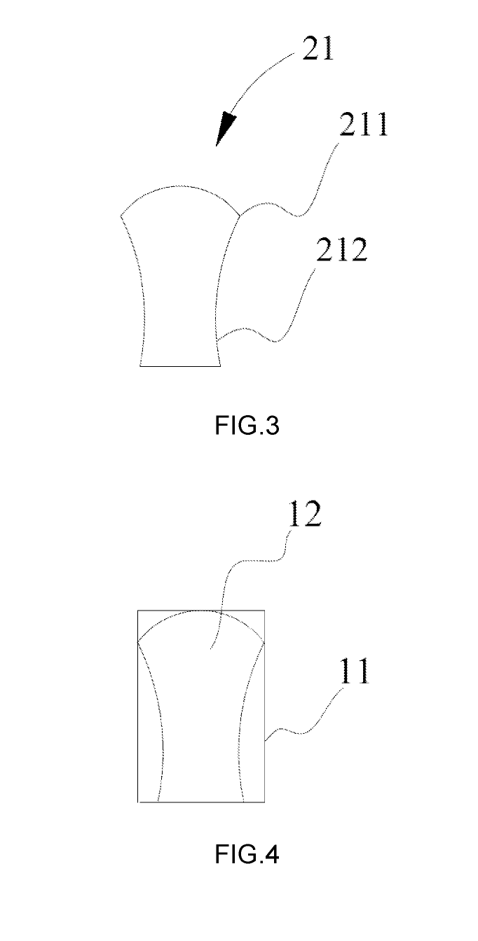

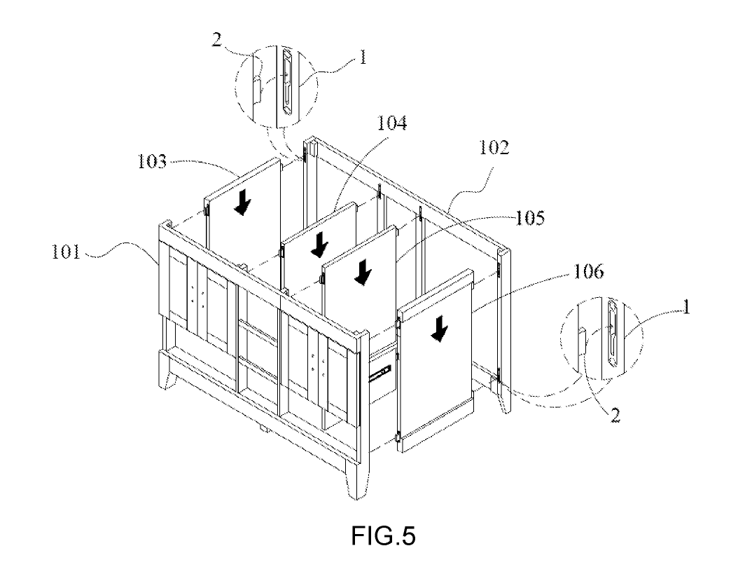

As shown in FIG. 2-3, the part 2 comprises a lug 21; transverse length of front part 211 of the said lug 21 exceeds that of the rear part 212. As shown in FIG. 1, the part 1 comprises a cavity; transverse and vertical length and height of upper part 11 of the cavity are respectively consistent with those of lug 21 of the part 2; profile and size of the lower part 12 of the cavity are consistent with those of lug 21 of the part 2.

It should be mentioned that when the two objects installed on part 1 and part 2 are to be spliced, the lug of part 2 is to be fully extended into the upper part of cavity of part 1 before moving downwards to insert the lug of part 2 into the lower part of the cavity of part 1 to realize connection of the two objects. It is quick and convenient, which can realize simple and easy separation of the two objects through reverse operation.

In a further embodiment, both sides of the part 2 are in a structure that bends inward.

FIG. 5 is the diagram for specific application of the said new connector. As shown in the figure, parts to be spliced comprise an enclosure plate 101 and 102 and a division plate 103, 104, 105 and 106. Wherein, enclosure plate 101 and 102 is to be connected to both sides of division plate 103, 104, 105 and 106; whereas all connection points are installed with aforesaid new connector. Wherein, upper and lower parts of both sides of division plate 103, 104, 105 and 106 are installed with part 2 of the new connector; whereas part 1 of the new connector is installed at the corresponding position on enclosure plate 101 and 102.

Technicians in this field can make various changes and modifications based on aforesaid technical solution and conception; whereas such changes and modifications are to be incorporated into the protection scope of Claims of the invention.

What is claimed is:

1. A new connector, characterized in that it comprise a part 1 and a part 2 as installed on the two objects to be spliced; the part 2 comprises a lug; transverse length of front part of the said lug exceeds that of the rear part; the part 1 comprises a cavity; transverse and vertical length and height of upper part of the cavity are respectively consistent with those of lug of the part 2; profile and size of the lower part of the cavity are consistent with those of lug of the part 2.

2. A new connector according to claim 1, characterized in that both sides of the part 2 is in a structure that bends inward.
